(19) United States
(12) Patent Application Publication
(10) Pub. No.: US 2025/0292289 A1
(43) Pub. Date: Sep. 18, 2025

(54) MACHINE LEARNING TECHNIQUES TO CONSTRUCT AND APPLY HOME VALUATION MODELS THAT TAKE INTO ACCOUNT INFORMATION DERIVED FROM PHOTOGRAPHS OF HOMES

(71) Applicant: MFTB Holdco, Inc., Seattle, WA (US)

(72) Inventors: Mohammad Moghimi, Shoreline, WA (US); David Fagnan, Seattle, WA (US); Stanley B. Humphries, Sammamish, WA (US); Nicholas Stevens, Seattle, WA (US); Jasjeet Thind, Seattle, WA (US); William Fedus, Montreal (CA)

(21) Appl. No.: 15/715,098

(22) Filed: Sep. 25, 2017

(51) Int. Cl. G06Q 30/02; G06N 5/02; G06N 20/00; G06Q 50/16

(52) U.S. Cl. CPC G06Q 30/0278; G06Q 50/16; G06N 5/027; G06N 20/00

(57) ABSTRACT

A home valuation facility is described. The facility accesses information about each of a plurality of homes sold in a geographic area during a distinguished period of time. The accessed information includes, for each home, a selling price for the home and one or more photos depicting the home. The facility uses the accessed information to train a statistical model for predicting the value of a home in the geographic area based on information about the home, including one or more photos depicting the home. The facility receives information about a distinguished home, including one or more photos depicting the distinguished home. The facility subjects the received information about the distinguished home to the trained statistical model to obtain a prediction of the distinguished home's value. The facility causes the obtained prediction of the distinguished home's value to be displayed together with information identifying the distinguished home.

### CROSS-REFERENCE TO RELATED APPLICATIONS

This application is related to the following applications, each of which is incorporated herein in its entirety by reference: U.S. patent application Ser. No. 11/347,000 filed Feb. 3, 2006, now U.S. Pat. No. 8,676,680, entitled “AUTOMATICALLY DETERMINING A CURRENT VALUE FOR A HOME;” U.S. patent application Ser. No. 11/347,024 filed Feb. 3, 2006, now U.S. Pat. No. 7,970,674, entitled “AUTOMATICALLY DETERMINING A CURRENT VALUE FOR A REAL ESTATE PROPERTY, SUCH AS A HOME, THAT IS TAILORED TO INPUT FROM A HUMAN USER, SUCH AS ITS OWNER;” U.S. patent application Ser. No. 11/524,048 filed Sep. 19, 2006, now U.S. Pat. No. 8,515,839, entitled “AUTOMATICALLY DETERMINING A CURRENT VALUE FOR A REAL ESTATE PROPERTY, SUCH AS A HOME, THAT IS TAILORED TO INPUT FROM A HUMAN USER, SUCH AS ITS OWNER;” U.S. patent application Ser. No. 11/971,758 filed Jan. 9, 2008, now U.S. Pat. No. 8,140,421, entitled “AUTOMATICALLY DETERMINING A CURRENT VALUE FOR A HOME;” and U.S. patent application Ser. No. 13/828,680, filed Mar. 14, 2013, entitled LISTING PRICE-BASED HOME VALUATION MODELS. In cases in which a document incorporated by reference herein is inconsistent with the disclosure of the present application, the disclosure of the present application controls.

### BACKGROUND

In many roles, it can be useful to be able to accurately determine the value of residential real estate properties (“homes”). As examples, by using accurate values for homes: taxing bodies can equitably set property tax levels; sellers and their agents can optimally set listing prices; buyers and their agents can determine appropriate offer amounts; insurance firms can properly value their insured assets; and mortgage companies can properly determine the value of the assets securing their loans.

A variety of conventional approaches exist for valuing houses. One is statistical modeling, in which home sale transactions in a particular geographic area are used to train a statistical model that seeks to predict the value of any home in the geographic area based upon retrieving from a government source values of attributes of the home such as latitude and longitude, number of bedrooms, number of bathrooms, interior floor space, lot size, etc.

### BRIEF DESCRIPTION OF THE DRAWINGS

FIG. 1 is a network diagram showing the environment in which the facility operates in some embodiments.

FIG. 2 is a block diagram showing some of the components typically incorporated in at least some of the computer systems and other devices on which the facility operates.

FIG. 3 is a data flow diagram illustrating the functions of the models employed by the facility in some embodiments.

FIG. 4 is a flow diagram showing a process performed by the facility in some embodiments to train the models used by the facility, then apply them in order to determine and present a valuation for one or more homes.

FIG. 5 is a flow diagram showing a process performed by the facility in some embodiments to train the photo quality level classification model and the photo scene classification model.

FIG. 6 is a flow diagram showing a process performed by the facility in some embodiments to train the valuation model.

FIG. 7 is a flow diagram showing a process performed by the facility in some embodiments to value a home.

FIG. 8 is a user interface diagram showing a visual user interface presented by the facility in some embodiments to present a valuation determined for particular home.

### DETAILED DESCRIPTION

The inventors have recognized disadvantages that attend all of the conventional approaches to valuing homes. In particular, the inventors have recognized that reliance by conventional statistical modeling techniques on government-supplied home attribute values in both constructing and applying the models can have material disadvantages. First, these government-supplied home attribute values may have always been incorrect for certain homes, having originally been inputted with incorrect values and never subsequently corrected. Also, the home attribute values supplied by government may have become “stale,” having been correct an earlier point in time, but not updated to reflect subsequent changes to the home, such as the addition of another floor. Further, even for homes for which these attributes are accurate and up-to-date, the inventors have recognized that the attributes frequently fail to capture differences between homes that are constructed and maintained at different levels of quality. Indeed, the inventors have determined that a home's level of quality—which is difficult or impossible to discern from government-supplied home attribute values, is a material factor in the purchase price of many homes, and thus can have a significant effect on the value of a home.

Accordingly, the inventors have conceived and reduced to practice a software and/or hardware facility that performs machine learning techniques to construct and apply home valuation models that take into account information derived from contemporaneous photographs of homes (“the facility”).

In some embodiments, for a particular geographic region the, the facility identifies the homes of the selected type in the selected region that were listed for sale and subsequently sold. For each such “observation” home, the facility identifies a price at which the home sold (“selling price”); home attribute values of the home; and recent or otherwise contemporaneous photos depicting the home.

The photos of the observation homes are each reviewed by a human editor, who provides two pieces of information about the photo: (1) the level of quality conveyed by the photo, such as on a scale from 1 to 10; and (2) the “scene” or “room type” depicted in the photo, such as one selected from a fixed list of scenes or room types, such as bedroom, kitchen, attic, dining room, etc. In some embodiments, rather than determining quality scores based on the input of a human editor, the facility automatically determines a quality score for each photo in a way that is based on the selling price (or valuation from another source) of the depicted home, such as, in various embodiments: selling price, selling price quantile within the geographic area, selling price per square foot, selling price per square foot quantile within the geographic area, etc.

For at least some of the observation homes, the photos and editor-provided quality level and scenes are used to train two classification models, such as convolutional neural networks. The facility trains a photo quality level classification model to predict the quality level that will be attributed to each photo by a human editor, and trains a photo scene classification model to predict the scene that will be attributed to each photo by a human editor.

The facility proceeds to use some or all of the observation homes to train a valuation model—such as a random forest valuation model. The valuation model bases its prediction of a home's value on independent variables of two types: (1) traditional home attribute values such as latitude/longitude, number of bedrooms, number of bathrooms, interior floor space, lot size, etc.; and (2) for each of the list of scenes, a quality value aggregated across the photos predicted to depict that scene and the quality levels predicted for those photos.

In order to value a home, the facility obtains contemporaneous photographs of the home, such as those uploaded or otherwise provided by the home's owner, a real estate agent, an appraiser, etc. the facility subjects each obtained photographs to the photo quality level classification model and photo scene classification model to predict the quality level and scene of the photo. For each scene in the list of scenes, the facility determines an aggregate quality level across the photos predicted to depict that scene, such as by determining the maximum, mean, median, etc. quality level predicted for these photos. Facility then applies the valuation model to the home's attribute values and aggregated per-scene photo quality levels to produce a valuation for the home.

In various embodiments, the valuation results produced by the facility for a home are presented in various ways, such as in a web page; in an email message; in a document attached to an email message; in an app or application program; in a text message; in a voice mail message; in a live telephone call; etc. In some embodiments, the facility presents the valuation results in connection with information identifying the home, such as its address, an indication of the home's location on a map, attribute values for the home, photographs of the home, etc.

In some embodiments, the facility provides this service with respect to homes in different geographic areas—e.g., different blocks, neighborhoods, zip codes, census areas, voting districts, school districts, cities, counties, states, provinces, countries, continents, or regions of other types—and/or homes of different home types—e.g., single-family homes, condominiums, vacant lots, etc.

In some embodiments, the facility is applied to determine a valuation for substantially every home in a geographic area, such as once, annually, monthly, weekly, daily, hourly, etc. In some embodiments, facility aggregates the valuations it determines for homes in a geographic area in order to obtain a housing price index for the geographic area, which in various embodiments the facility presents in a variety of ways.

By performing in some or all of these ways, the facility more accurately values homes. Also, performing in some or all of these ways, the facility reduces the levels of computing resources that would otherwise be required to provide similar kinds of services, allowing them to be provided with fewer and/or less powerful and/or less costly computing devices; fewer and/or less capacious and/or less costly storage devices; less network capacity; less latency; etc.

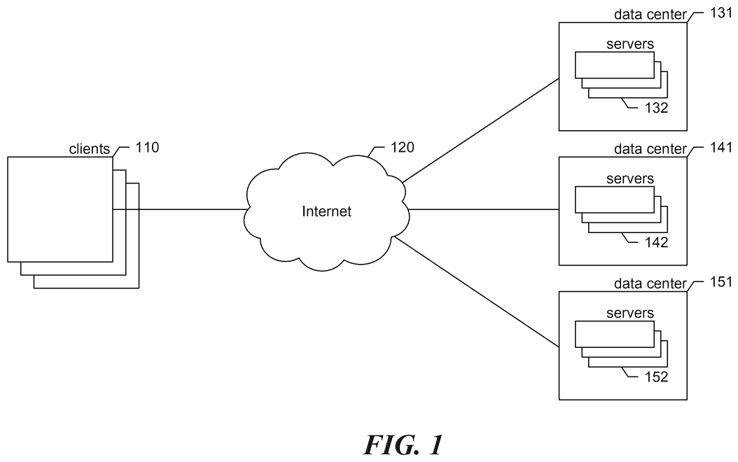

FIG. 1 is a network diagram showing the environment in which the facility operates in some embodiments. The network diagram shows clients 110 each being used by a different user. Each of the clients executes software, such as web browsers, to communicate with one or more servers 132, 142, and 152 in data centers 131, 141, and 151 via the Internet 120 or one or more other networks. In some embodiments, the data centers are distributed geographically to provide disaster and outage survivability, both in terms of data integrity and in terms of continuous availability. Distributing the data centers geographically also helps to minimize communications latency with clients in various geographic locations.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different devices may be used as clients, including desktop computer systems, laptop computer systems, automobile computer systems, tablet computer systems, smart phones, personal digital assistants, televisions, cameras, etc.

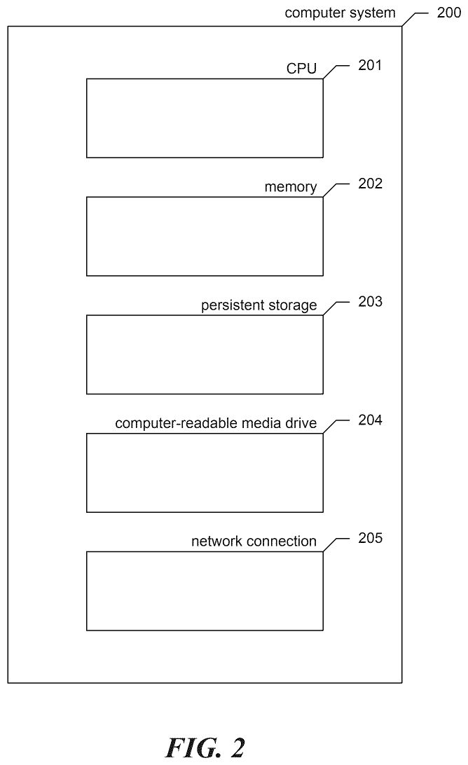

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”), graphics processing unit (“GPU”), or other processor 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

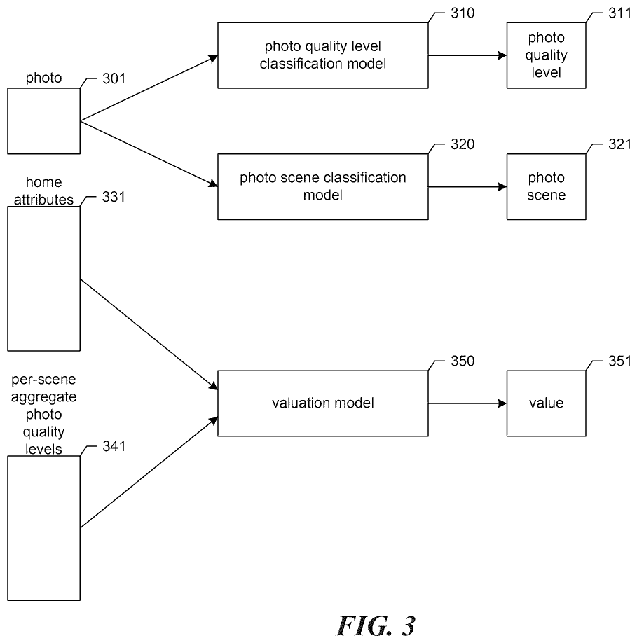

FIG. 3 is a data flow diagram illustrating the functions of the models employed by the facility in some embodiments. The facility applies a photo quality level classification model 310 to transform any photo 301 depicting a home into a photo quality level 311 discerned from the photo. The facility applies a photo scene classification model 320 to transform any photo depicting a home into a scene depicted in the photo. The facility applies a valuation model 350 to obtain a value prediction for a home based on (1) attributes 331 of the home, and (2) values obtained by, for each scene depicted by any of the photos depicting the home, aggregating the photo quality levels of the photos depicting that scene.

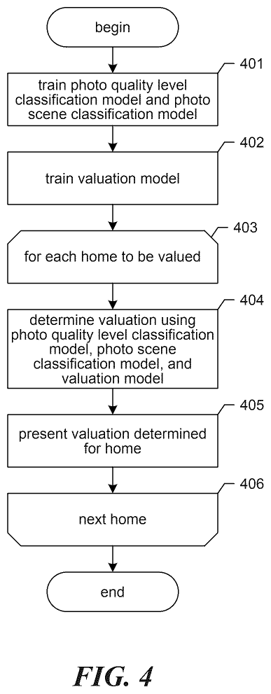

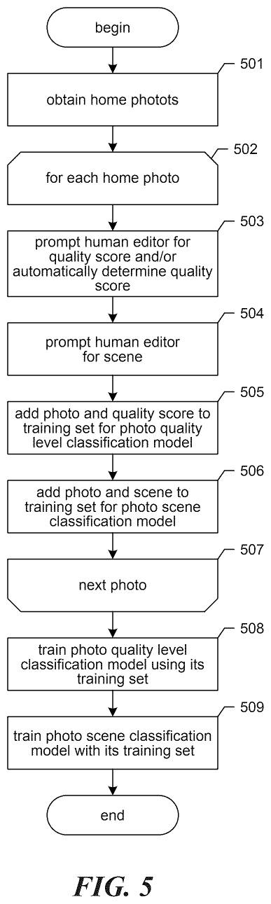

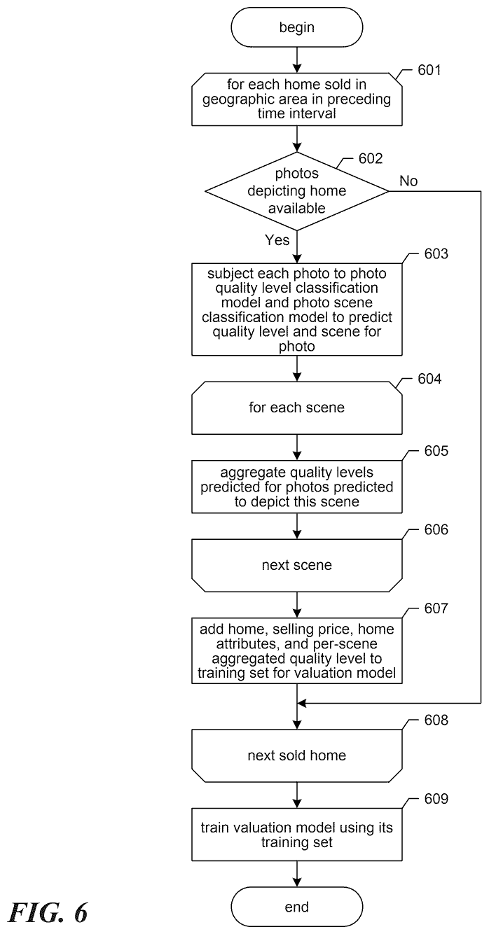

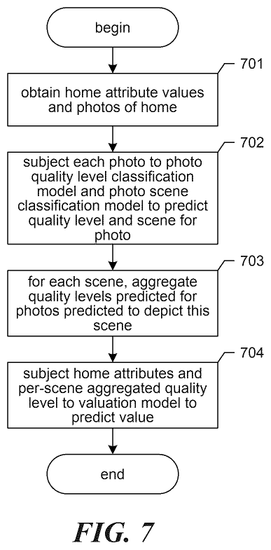

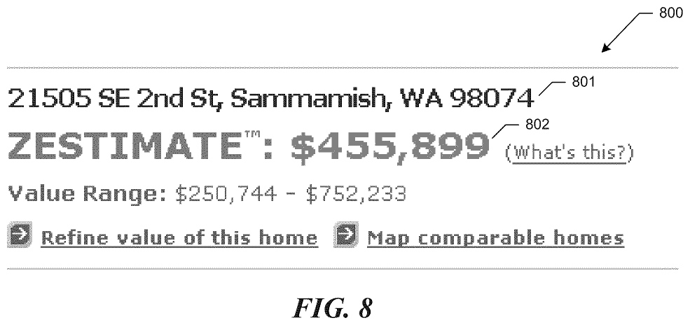

FIG. 4 is a flow diagram showing a process performed by the facility in some embodiments to train the models used by the facility, then apply them in order to determine and present a valuation for one or more homes. In act 401, the facility trains both the photo quality level classification model and the photo scene classification model. The facility's performance of act 401 is discussed in greater detail below in connection with FIG. 5. In act 402, the facility trains the valuation model. The facility's performance of act 402 is discussed in greater detail below in connection with FIG. 6. In acts 403-406, the facility loops through each home to be valued. In various embodiments, the operation of this loop corresponds to servicing individual valuation requests each specifying a particular home; seeking to value all the homes in a geographic region, such as periodically; etc. In act 404, the facility determines evaluation of the home to be valued using the photo quality level classification model, the photo scene classification model, and the valuation model. The facility's performance of act 404 is discussed in greater detail below in connection with FIG. 7. In act 405, the facility presents the valuation determined for the home in act 404. FIG. 8 shows an example of such presentation. In act 406, if another home is to be valued, then the facility continues in act 403 to value the next home, else this process concludes.

Those skilled in the art will appreciate that the acts shown in FIG. 4 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 5 is a flow diagram showing a process performed by the facility in some embodiments to train the photo quality level classification model and the photo scene classification model. In act 501, the facility obtains photos of a number of different homes. In acts 502-507, the facility loops through each home photo obtained in act 501. In act 503, the facility prompts a human editor for quality score reflected by the photo. In various embodiments, this quality score takes a number of forms, such as a numerical score between 1 and 10, numerical score between 1 and 100, etc. In some embodiments, instead of or in addition to soliciting a quality score from a human editor, the facility automatically determines a quality score for the photo. In some such embodiments, the facility determines a quality score for the photo using a selling price for the home, such as by: using the selling price in its original form as the quality score; dividing the selling price by the interior area of the home; determining, within the geographic area, a statistical quantile of either the selling price or the selling price square-foot, such as quartile, decile, percentile, etc.

In act 504, the facility prompts a human editor to classify the room type or other scene depicted in the photo. In some embodiments, the facility causes this classification to be performed in accordance with a list of scenes such as Places or Places2, described at places.csail.mit.edu/, which is hereby incorporated by reference in its entirety. (In some embodiments, in place of acts 504 and 509, the facility uses a pre-trained scene classification model, such as one available in connection with Places or Places2.) In act 505, the facility adds the photo and the quality score determined in act 503 for it to a training set for the photo quality level classification model. In act 506, the facility adds the photo and the scene determined for it in act 504 to the training set for the photo scene classification model. In act 507, if additional photos remain to be processed, then the facility continues in act 502, else the facility continues in act 508.

In act 508, the facility trains the photo quality level classification model using the training set established in act 505. In act 509, the facility trains the photo scene classification model using the training set established in act 506. In some embodiments, one or both of these classification models is a convolutional neural network. In some embodiments, one or both of these classification models is organized as neural network layers assembled in the sequence shown below in Table 1:

TABLE 1

| layer | | input | number of | | |
|---|---|---|---|---|---|
| name | layer type | dimension | channels | memory | |
| data | data | 227 × 227 | 3 | activation | 77.29M |
| | | | | activation | 145.2M |
| conv1 | convolution | 227 × 227 | 96 | param | 34.85k |
| relu1 | relu | 55 × 55 | 96 | activation | 145.2M |
| pool1 | pooling | 55 × 55 | 96 | activation | 34.99M |
| | | | | activation | 34.99M |
| | | | | param | 2 |
| norm1 | lrn | 27 × 27 | 96 | | |
| | | | | activation | 93.31M |
| conv2 | convolution | 27 × 27 | 256 | param | 307.2k |
| relu2 | relu | 27 × 27 | 256 | activation | 93.31M |
| pool2 | pooling | 27 × 27 | 256 | activation | 21.63M |
| | | | | activation | 21.63M |
| | | | | param | 2 |
| norm2 | lrn | 13 × 13 | 256 | | |
| | | | | activation | 32.45M |
| conv3 | convolution | 13 × 13 | 384 | param | 884.74k |
| relu3 | relu | 13 × 13 | 384 | activation | 32.45M |
| | | | | activation | 32.45M |
| conv4 | convolution | 13 × 13 | 384 | param | 663.55k |
| relu4 | relu | 13 × 13 | 384 | activation | 32.45M |
| | | | | activation | 21.63M |
| conv5 | convolution | 13 × 13 | 256 | param | 442.37k |
| relu5 | relu | 13 × 13 | 256 | activation | 21.63M |
| pool5 | pooling | 13 × 13 | 256 | activation | 4.61M |
| | | | | activation | 2.05M |
| fc6 | inner_product | 6 × 6 | 4096 | param | 37.75M |
| relu6 | relu | 1 × 1 | 4096 | activation | 2.05M |
| drop6 | dropout | 1 × 1 | 4096 | activation | 2.05M |
| | | | | activation | 2.05M |
| fc7 | inner_product | 1 × 1 | 4096 | param | 16.78M |
| relu7 | relu | 1 × 1 | 4096 | activation | 2.05M |
| drop7 | dropout | 1 × 1 | 4096 | activation | 2.05M |
| | | | | activation | 500 |
| fc9 | inner_product | 1 × 1 | 1 | param | 4.1k |
| | | | | activation | 500 |
| prob | softmax | 1 × 1 | 1 | | |

A more detailed discussion of layers of these types is contained, for example, by the following, each of which is incorporated herein by reference in its entirety: Andrej Karpathy, CS231 n Convolutional Neural Networks for Visual Recognition, available at cs231n.github.io/convolutional-networks/; Abhineet Saxena, Convolutional Neural Networks (CNNs): An Illustrated Explanation, available at xrds.acm.org/blog/2016/06/convolutional-neural-networks-cnns-illustrated-explanation/; Vivek Yadav, Why dropouts prevent overfitting in Deep Neural Networks, available at medium.com/®vivek.yadav/why-dropouts-prevent-overfitting-in-deep-neural-networks-937e2543a701; and Nitish Srivastava et. al, Dropout: A Simple Way to Prevent Neural Networks from Overfitting, Journal of Machine Learning Research 15 (2014) 1929-1958, available at www.cs.toronto.edu/˜hinton/absps/JMLRdropout.pdf.

Additional details about useful arrangements of such layers used by the facility in some embodiments are provided by B. Zhou et al., “Learning Deep Feature Recognition Using Places Database,” NIPS 2014, and A. Krizhevsky et al. “ImageNet Classification with Deep Convolutional Neural Networks,” each of which is incorporated herein in its entirety by reference.

In some embodiments, the facility implements one or both of these classification models using the Berkeley Caffe Deep Learning Framework, available at caffe.berkeleyvision.org, which is incorporated herein by reference in its entirety

After act 509, this process concludes.

FIG. 6 is a flow diagram showing a process performed by the facility in some embodiments to train the valuation model. In acts 601-608, the facility loops through each home sold in the geographic area to which the valuation model corresponds in a preceding time interval, such as the past three months, the past six months, the past nine months, the past year, the past two years, the past three years, etc. In act 602, if photos depicting the home are available, then the facility continues in act 603, else the facility continues in act 608. In some embodiments, rather than skipping a home for which photos are not available by proceeding directly to act 608, the facility imputes quality scores to the home for one or more scenes using a variety of quality score imputation techniques (not shown), then proceeds to act 607 to add the home to the training set for the valuation model (not shown). In act 603, the facility subjects each photo to both the photo quality level classification model and the photo scene classification model to predict the quality level and scene for each photo. In acts 604-606, the facility loops through each scene identified for at least one of the home's photos. In act 605, the facility aggregates the quality levels predicted in act 603 for the photos predicted in act 603 to depict the current scene. In act 606, if additional scenes remain to be processed, then the facility continues in act 604 to process the next scene, else the facility continues in act 604. In act 607, the facility adds the home, its selling price, its home attribute values, and the per-scene aggregated quality levels determined in act 605 to the training set for the valuation model. In act 608, if additional sold homes remain to be processed, than the facility continues in act 601 to process the next sold homes, else the facility continues in act 609. In act 609, the facility trains the valuation model using the training set collected in act 607. In some embodiments, the valuation model that the facility trains in act 609 is a random forest model. In some embodiments, the facility trains the valuation model in ways described, for example, in U.S. Pat. No. 8,140,421. After act 609, this process concludes.

FIG. 7 is a flow diagram showing a process performed by the facility in some embodiments to value a home. In act 701, the facility obtains home attribute values and photos of the home. In some embodiments, the facility obtains the home attribute values from a government source, such as a county property tax assessor's office. In some embodiments, the home attribute values are obtained from a broker or an intermediary of another type. In some embodiments, the home attribute values are adjusted by an owner of the home or someone else knowledgeable about the home, such as via a real estate information website that contains a page displaying information about the home. In some embodiments, an owner or someone else uses such a real estate information website to upload the photos in connection with the home.

In act 702, the facility subjects each photo obtained in act 701 to the photo quality level classification model and the photo scene classification model to predict the quality level and scene of each photo. In act 703, for each scene identified by the facility in at least one of the obtained photos, the facility aggregates the quality levels predicted for the corresponding photos. In act 704, the facility subjects the home attribute values obtained in act 701 and the per-scene aggregated quality levels determined in act 703 to the valuation model to predict the value of the home. After act 704, this process concludes.

FIG. 8 is a user interface diagram showing a visual user interface presented by the facility in some embodiments to present a valuation determined for particular home. The visual user interface 800 includes identifying information 801 for the home, as well as a value 802 determined for the home. In various amendment, the facility uses a variety of other user interfaces to present this information.

In some embodiments, rather than training and applying three separate models to value homes, the facility trains and applies a single model that takes as its independent variables (1) home attribute values, and (2) home photos, and predicts home value based on these. In some embodiments, this single, monolithic valuation model is a neural network.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

1. A method of training machine learning models in a computing system configured for predicting home values, the method comprising:
training a home valuation system to determine a value of a home in a geographic area, the home valuation system comprising a photo scene classification model, a photo quality level classification model, and a valuation model, wherein an output of the photo scene classification model and an output of the photo quality level classification model are connected to an input of the valuation model, and wherein training the home valuation system comprises:
training, using a plurality of photos associated with a plurality of homes in the geographic area, the photo scene classification model, wherein the photo scene classification model is trained to determine, for an input photo, a scene classification from among defined scene classifications including one or more room types:
training, using the plurality of photos associated with the plurality of homes in the geographic area, the photo quality level classification model, wherein the photo quality level classification model is trained to determine, for the input photo, a quality classification; and
after training the photo scene classification model and the photo quality level classification model, training, using scene classifications output by the photo scene classification model and quality classifications output by the photo quality level classification model, the valuation model for predicting the value of a home in the geographic area based on one or more home attribute values of the home, one or more scene classifications associated with one or more photos of the home, and one or more quality classifications associated with the one or more photos of the home; and
periodically obtaining a house price index for the geographic area at least in part by, for each of substantially every home in the geographic area,
receiving information about the home, the received information including one or more home attribute values for the home and one or more photos depicting the home; and
subjecting the received information about the home to the trained home valuation system to obtain a predicted value of the home, wherein the subjecting comprises:
for each photo of the one or more photos depicting the home:
determining, using the photo scene classification model, a scene classification; and
determining, using the photo quality level classification model, a quality classification;
calculating, based on the scene classification and quality classification for each photo of the one or more photos depicting the home, one or more aggregated quality values, each aggregated quality value being associated with a scene classification determined for the one or more photos; and
determining, using the valuation model, a predicted value of the home based on the one or more home attribute values and the one or more aggregated quality values; and
using the obtained predicted values to obtain the housing price index for the geographic area.

2-6. (canceled)

7. The method of claim 1, wherein the photo scene classification model is further trained using information reflecting a selling price per square foot of the home portrayed in each photograph.

8. (canceled)

9. The method of claim 1 wherein the photo scene classification model is further trained based on a scene classification input on each photo generated by at least one human editor, and wherein the photo quality level classification model is further trained based on a quality classification input on each photo generated by the at least one human editor.

10-11. (canceled)

12. The method of claim 1, further comprising:
determining the aggregated quality values includes applying, to each quality classification associated with a scene classification, a mean, median, mode, maximum, or minimum aggregation function.

13-14. (canceled)

15. The method of claim 1 wherein the photo scene classification model comprises a sequence of layers including one or more convolutional layers, the convolutional layers preceding one or more pooling layers, the pooling layers preceding one or more normalization layers, the normalization layers preceding one or more fully connected layers.

16. The method of claim 1 wherein the photo scene classification model comprises a sequence of layers including two or more convolution/pooling cycles, each convolution/pooling cycle comprising a convolutional layer preceding one or more pooling layers, the convolution/pooling cycles preceding one or more fully connected layers.

17-33. (canceled)

34. The method of claim 1, further comprising:
for each photo of the plurality of photos associated with the plurality of homes in the geographic area,
prompting a user for a quality score for the photo,
receiving, from the user, the quality score for the photo, and
adding the photo and the quality score for the photo received from the user to a training set for the photo quality level classification model.

35. The method of claim 1, further comprising:
for each photo of the plurality of photos associated with the plurality of homes in the geographic area,
prompting a user for a classification of a room type depicted in the photo, receiving, from the user, the classification of the room type depicted in the photo, and
adding the photo and the classification of the room type depicted in the photo received from the user to a training set for the photo scene classification model.

36. The method of claim 1, wherein using the obtained predicted values to obtain the housing price index comprises aggregating the obtained predicted values.

37. (canceled)

38. The method of claim 1, wherein a training set for photo quality level classification model includes a quality score that is determined based on an interior area of the home and a quantile of a selling price within the geographic area.

39. A computer-implemented system for predicting home values, the system comprising:
a computing system including a processor and a memory operatively connected to the processor and storing:
a photo quality level classification model trained using a plurality of quality classification training photos and a plurality of corresponding quality classifications to generate, in response to an input photo, a quality classification of the input photo;
a photo scene classification model trained using a plurality of scene classification training photos and a plurality of corresponding scene classifications, the photo scene classification model being a classifier model configured to determine, for the input photo, a scene classification from among defined scene classifications including one or more room types;
a valuation model communicatively linked to outputs of the photo quality level classification model and the photo scene classification model, the valuation model being trained using training data including the input photo, the scene classification generated for the input photo by the trained photo quality level classification model, the quality classification generated for the input photo by the trained photo scene classification model, and an actual home value of a property corresponding to the input photo;
wherein the valuation model is trained to generate, in response to receiving a second input photo corresponding to a scene of a home, a quality classification of the second input photo from the photo quality level classification model, and a scene classification of the second input photo from among the one or more room types, a valuation of the home;
wherein the memory further stores instructions which, when executed cause display of a user interface including identifying information for the home and the valuation of the home.

40. The computer-implemented system of claim 39, wherein the plurality of corresponding quality classifications includes one or more human annotated quality scores.

41. The computer-implemented system of claim 39, wherein the plurality of corresponding scene classifications includes one or more human annotated scene classifications.

42. The computer-implemented system of claim 39, wherein the actual home value is derived from a sale price of the property.

43. The computer-implemented system of claim 39, wherein one or more of the plurality of corresponding quality classifications corresponds to an imputed quality classification based on a score imputation technique, the imputed quality classification being determined in response to a determination that a photo of a particular scene is unavailable.

44. The computer-implemented system of claim 39, wherein the valuation model obtains the valuation of the home based on a plurality of second input photos associated with the home corresponding to different scenes within the home, each scene having an associated scene classification and an associated quality classification.
